(19) United States
(12) Patent Application Publication
(10) Pub. No.: US 2023/0364894 A1
(43) Pub. Date: Nov. 16, 2023

(54) Low Force-To-Stretch Film, Prestretched In-Process, and Compositions Therefore

(71) Applicant: Paragon Films, Inc., Broken Arrow, OK (US)

(72) Inventor: Tom ROUDEBUSH, Broken Arrow, OK (US)

(21) Appl. No.: 18/224,332

(22) Filed: Jul. 20, 2023

Related U.S. Application Data
(63) Continuation of application No. 17/715,410, filed on Apr. 7, 2022, now abandoned.
(60) Provisional application No. 63/171,760, filed on Apr. 7, 2021.

(51) Int. Cl. B32B 27/08; B32B 27/32; C08L 23/06; B32B 37/00; B32B 3/26; B32B 3/04

(52) U.S. Cl. CPC B32B 27/08; B32B 27/32; C08L 23/06; B32B 37/0053; B32B 3/266; C08L 2205/03; C08L 2205/025; C08L 2203/16; B32B 3/04

(57) ABSTRACT

Plastics, for example, stretch films, and chemical compositions therefore are disclosed for use when manufacturing low force-to-stretch films that have been pre-stretched in-process.

### CROSS-REFERENCES TO RELATED APPLICATIONS

This patent application claims benefit of U.S. patent application Ser. No. 17/715,410, filed Apr. 7, 2022, which claims the benefit of U.S. Provisional Patent Application No. 63/171,760, filed Apr. 7, 2021, the contents of which are hereby incorporated by reference in, their entirety.

### FIELD

The present invention relates generally to stretch films, and in a particular through non-limiting embodiment to a means for manufacturing low force-to-stretch films that have been pre-stretched in process. Manufacturing methods and suitable compositions are also disclosed.

### BACKGROUND

Stretch films are widely used in a variety of bundling and packaging applications. For example, stretch films have become a common method of securing bulky loads such as boxes, merchandise, produce, equipment, parts, and other similar items on pallets. Stretch films are typically made from various polyethylene resins and may be single or multilayer products. An additive known as a cling agent is frequently used to ensure that adjacent layers of film will dim, to each other.

An issue with conventional stretch films is that the edges of the film can be easily damaged, which may result in tearing or failure of the film during use. Typically, the edges of the film are prepared by transversely slitting individual roll widths of film from a wider width of film by means of a conventional sharp edge slitter assembly. Any defects introduced into the edges of the film during the slitting process can result in film failure during the application process. Dropping the film roll or any other abuse during handling may also create zones of weakness or tears in the edges of the film.

One method of reinforcing the edges of the film is to fold the edges of the film to form a hem. For example, U.S. Pat. No. 5,565,222 discloses an apparatus for hemming the edges of stretch film. The apparatus consists of a first hemming roller with a width less than the width of the film, guide bars located adjacent to the film's path of travel, and a second hemming roller. As another example, U.S. Pat. No. 5,531,393 discloses a film with folded edges. Folding is achieved by means of folding fingers that project inwardly from the side, plates of the apparatus. In both of the previously mentioned methods, the folding is performed post-production in a separate and secondary process.

These hems, however, cause difficulties in winding a uniform roll of film due to the essentially double thickness of the hemmed edge as compared to the remainder of the film. Oscillating the film as it is wound onto the roll can prevent the hemmed edges from stacking on top of one another, thus producing a roll with uniform dimensions.

U.S. Pat. No. 5,531,393 discloses an apparatus where the roll onto which the film is wound is oscillated to prevent stacking of the folds in the film's edges. The oscillation is controlled by a piston reciprocating between two limit positions, which moves a cap inserted into the hollow end of the film roll. U.S. Pat. No. 5,967,437 discloses a means for oscillating the film, preferably by rectilinear motion of either the feed roller or the film roll along its axis. However, the disclosure results in film rolls with frustoconical or substantially conical end zones.

Improved, more reliable methods and means for slitting and folding stretch films in-line during manufacture, and for oscillating and winding the film onto a finishing roll using a winder are taught, for example, in U.S. Pat. Nos. 8,100,356; 8,221,298; 8,475,349; and 8,777,829. New and inexpensive resins and other chemistry platforms useful for making high-end films at a reasonable price remain elusive, however.

There is, therefore, a longstanding but unmet need for methods, systems, and devices to produce uniform, flat rolls of film in-process so that they can be easily stored, transported, and used. There is also a need for methods, systems, and devices to make film rolls less susceptible to damage during shipment and use, thus reducing wastage. In addition, there is a need to facilitate the unwinding of the film, making the film easier for the operator to use. There is also a distinct need for next generation chemical matrices admitting to manufacture and distribution of reliable, relatively inexpensive, pre-stretched films.

### DETAILED DESCRIPTION

An example object of the invention is to fold, oscillate, and entrap air during manufacture in such a manner that a high-end film results that has durable sides, oscillated edge reinforcement, and air purposefully entrapped within the sheet, thereby resulting in less expensive stretch films having properties formerly offered by only the industry's most expensive products.

In one example of the manufacturing process, example steps for producing cast film in-process according to an embodiment of the present disclosure are disclosed. In one embodiment, the steps comprise producing a film from molten resins, gauging the film, longitudinally slitting the film into multiple sections, folding the edges of the film, oscillating the film, and winding the film onto a film roll in a manner that prevents stacking of the edge folds and entraps air between the layers of film. All of the steps may be performed in-process along a single production line. The steps may be performed in a different order, and one or more steps may be eliminated without departing from the scope of the present disclosure.

Slitting assemblies are known in the industry, and the present disclosure may use any conventional slitting assembly to slit the film into multiple sections. An interior slit may be defined as a slit made somewhere within the original width of film, resulting in multiple sections of lesser width. Each interior slit may require only one folding guide assembly to accommodate both adjacent film edges. An exterior slit may be defined as a slit made along one of the edges of the original width of film. Each exterior edge may require a separate folding guide assembly.

In another embodiment, the edges of the film are folded immediately after the film is longitudinally slit into multiple sections. The edge folds may make the film less susceptible to failure due to tears, rough handling-, dropping, or excessive stretching. Thus, the ability to introduce and maintain edge folds is a key component of film performance.

In a further embodiment, the means for folding the edges of the film comprises a first idler roll, a second idler roll, and a plurality of folding guide assemblies also known as folding guides, placed between the first idler roll and the second idler roll. Each folding guide assembly may be comprised of steel, aluminum, nylon, or any other material of sufficient modulus to be able to maintain rigidity with no one material demonstrating an advantage. Each folding guide assembly may also have a coefficient of friction that allows the edge of the film to turn back on itself, thus introducing a fold. The diameter and placement of the folding guide assemblies may be key factors in achieving and maintaining edge folds without roping or wrinkling of the film.

The folding guide assemblies may be comprised of a plurality of folding rods, which may be placed in the slits between sections of film to separate the sections of film. After the sections of film are separated, the cling agent and the tension of the film may cause the edge folds to form spontaneously. Each interior folding rod may produce two edge folds, while each exterior folding rod may produce one edge fold.

The folding rods will vary from in diameter, with a currently preferred (though non-limiting) diameter of approximately 1 inch or less. The folding rods may have uniform diameter throughout their length. As an alternative, the portions of the folding rods that contact the film may have a smaller diameter or narrow to a point to further aid in separating the sections, of film.

The folding rods may be placed in the slits between sections of the film at a guide distance and a guide angle. The guide distance may be approximately ⅔ of the distance between the first idler roll and the second idler roll, as measured from the point where the film leaves the first idler roll to the point where the film first contacts the folding rods. The guide angle between the film and the folding rods, measured with the folding rods leaning toward the first idler roll, may vary from 20 degrees to 90 degrees, with a presently preferred (though non-limiting) angle of approximately 45 degrees.

In a still further embodiment, the folding guide assemblies may also be comprised of a plurality of folding rods and a plurality of re-folders. Each folding rod and each re-folder may be separate units that can be positioned independently. Alternatively, each folding rod and each re-folder may be combined into a single unit. If the folding rod and re-folder are combined into a single unit, their positions may be fixed or adjustable relative to each other.

The re-folders may be placed in the slits between sections of the film after the folding rods and before the second idler roll. The re-folders may function to further separate the sections of film, and to direct the film back onto itself at an angle that aids in re-establishing folds that are lost during the production process. Causes of lost folds include, but are not limited to, holes, gels, contaminated resins, flaws in the film, and other production problems.

The composition and diameter of the re-folders may be comparable to that of the folding rods. The re-folders may have uniform diameter throughout their length. However, the portions of the re-folders that contact the film may be wider than the other portions of the re-folders in order to increase the amount of separation between adjacent sections of the film. For example, the portions of the re-folders that contact the film may be capped by an inverted cone or sphere.

In yet another embodiment, the means for folding the edges of the film may also comprise a nip roll assembly. The nip roll assembly may comprise two rollers pressed together, and may be primarily intended to control the tension of the film as it passes through the slitting assembly and the edge folding apparatus. The nip roll assembly may also aid in pressing the folds into the film, resulting in a plurality of flat edge folds. If the nip roll assembly is not employed, air entrapment may occur within the edge folds. Air entrapment within the edge folds may result in a film roll with a different appearance and functionality, much like having bubble wrap on the ends of the roll.

As yet another embodiment, the film maybe oscillated and wound onto film rolls once the film's edges are folded. Oscillation may efficiently distribute the edge folds onto the film roll. In addition, air may be entrapped between the layers of film as the film is wound onto a film roll, making the film easier to unwind and less susceptible to damage.

In another embodiment, and turning now to specific chemical compositions useful for putting into practice the claimed invention, an example formulation used is a LLDPE 2 MI butene skin and a LLDPE 1MI Hexene in the core layer (where MI=melting index). The lower MI in the core lends the film additional stiffness and better puncture resistance when using Hexene instead of butene.

In a further embodiment still, the skin layers further comprise a PIB (a Polyisobutylene additive), which can be liquid injected, and provides cling properties to both skins of the film.

Such resin structures also produce a much softer or lower Force-To-Stretch (FTS) film, which would lend advantage to a customer that would prefer a film that does not need as much load containment and gives them an option to apply less force to the load.

Ordinarily skilled artisans will appreciate that if made with other compositions and/or using older technologies, films competing in the same market will find that achieving a lower FTS due to the need to pre-stretch the film to get down to a thinner gauge will be very difficult, since the process of pre-stretching inherently makes the film stiffer and leads to a higher FTS.

In view of the foregoing, one of skill in the art will readily observe that production of such films using the machines and methods discussed herein admits to a distinct advantage for offering a lower cost formulation over our competitors. A secondary process to produce a low cost film is therefore not necessary.

From the foregoing, it will be understood by persons skilled in the art that devices, systems, and methods for folding the edges of the film have been provided, resulting in a film that is less susceptible to damage and easier to use. While the description contains many specifics, these should not be construed as limitations on the scope of the present disclosure, but rather as an exemplification of the preferred embodiments thereof. The foregoing is considered as illustrative only of the principles of the present disclosure. Further, because numerous modifications and changes will readily occur to those skilled in the art, it is not desired to limit the present disclosure to the exact methodology shown and described, and accordingly all suitable modifications and equivalents may be resorted to, falling within the scope of the present disclosure. Although this disclosure has been described in its preferred form with a certain degree of particularity, it is understood that the present disclosure of the preferred form has been made only by way of example and numerous changes in the details of the method may be resorted to without departing from the spirit and scope of the present disclosure.

1. A chemical composition for plastics including post-consumer recyclables, said
composition comprising:
a LLDPE 2 MI butene skin and a LLDPE 1MI Hexene in a core layer; and
a Polyisobutylene additive used to provide improved cling properties to both skins of the film.
